(19) United States
(12) Patent Application Publication
(10) Pub. No.: US 2024/0098782 A1
(43) Pub. Date: Mar. 21, 2024

(54) METHODS AND APPARATUS FOR HANDLING LISTEN BEFORE TALK (LBT) FAILURE FOR SIDELINK TRANSMISSION

(71) Applicant: LENOVO (BEIJING) LIMITED, Beijing (CN)

(72) Inventors: Jing HAN, Beijing (CN); Haipeng LEI, Beijing (CN); Ran YUE, Beijing (CN); Haiming WANG, Beijing (CN); Lianhai WU, Beijing (CN)

(21) Appl. No.: 18/263,231

(22) PCT Filed: Jan. 27, 2021
(86) PCT No.: PCT/CN2021/073993

§ 371 Date: Jul. 27, 2023

(51) Int. Cl. H04W 74/08; H04W 74/00

(52) U.S. Cl. CPC H04W 74/0808; H04W 74/004

(57) ABSTRACT

Embodiments of the present disclosure relate to methods, apparatuses, and media for handling Listen Before Talk (LBT) failure for sidelink transmission. A method performed by a terminal device comprises in response to at least one LBT failure during a sidelink transmission procedure, determining one or more resources for transmitting data that has failed to be transmitted from the terminal device due to the at least one LBT failure and transmitting the data from the terminal device via the one or more resources as determined. In the present disclosure, a mechanism for data retransmission cause by the LBT failure in the sidelink commutation is specified, which is benefit for the sidelink to co-exist with other wireless technologies in NR.

### TECHNICAL FIELD

Embodiments of the present disclosure generally relate to the field of telecommunication, and in particular, to methods and apparatuses for handling Listen Before Talk (LBT) failure for sidelink transmission.

### BACKGROUND

The New Radio (NR) operation in unlicensed bands relies on the transmitting device sensing the radio resources before commencing transmission. This technique is known as Listen Before Talk (LBT). In NR-based Access to Unlicensed Spectrum (NR-U), to co-exist with other wireless technology on unlicensed band e.g. Wi-Fi system, the LBT can be performed before each transmission to occupy the channel. If LBT is failed, which means the channel is already occupied and corresponding transmission will be dropped. In this case, an LBT failure indication can be sent to the Media Access Control (MAC) entity from lower layers. This procedure can happen for both a User Equipment (UE) side and a NodeB in new radio access (gNB) side.

The sidelink transmission may also operate on the unlicensed band, e.g. for public safety scenario or commercial sidelink scenario. In this case, the LBT mechanism in NR-U needs to be introduced for the sidelink transmission, to co-exist with other wireless systems on the unlicensed band. Before each sidelink transmission, the sidelink UE needs to perform LBT and drop the sidelink transmission if LBT fails.

### SUMMARY

In general, example embodiments of the present disclosure provide a solution for handling LBT failure for sidelink transmission.

In a first aspect, there is provided a method performed by a terminal device. The method comprises in response to at least one LBT failure during a sidelink transmission procedure, determining one or more resources for transmitting data from the terminal device, the data has failed to be transmitted due to the at least one LBT failure and transmitting the data from the terminal device via the one or more resources as determined.

In a second aspect, there is provided an apparatus. The apparatus includes a processor; and a memory coupled to the processor and storing instructions thereon, the instructions, when executed by the processor, causing the apparatus to perform the method according to the first aspect.

In a third aspect, there is provided a computer readable medium having instructions stored thereon, the instructions, when executed on at least one processor, causing the at least one processor to carry out the method according to the first aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a block diagram of a communication system in which embodiments of the present disclosure can be implemented;

FIG. 2 illustrates a signaling chart demonstrating an example process for handling LBT failure during a sidelink transmission according to some embodiments of the present disclosure;

FIGS. 3A-3D illustrate exemplary scenarios of resource request and resource selection during a sidelink retransmission caused by LBT failure according to some embodiments of the present disclosure;

FIG. 4 illustrates a signaling chart demonstrating an example process for handling LBT failure during a sidelink transmission according to some embodiments of the present disclosure;

FIGS. 5A and 5B illustrate exemplary scenarios for triggering a resource reselection for a sidelink retransmission caused by LBT failure according to some embodiments of the present disclosure;

FIG. 6 illustrates a flowchart of an example method for handling LBT failure during a sidelink transmission according to some embodiments of the present disclosure;

FIG. 7 is a simplified block diagram of an apparatus that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices or evolved MTC (eMTC) devices, devices on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

Communication discussed herein may conform to any suitable wireless interface standards including, but not limited to, New Radio Access (NR), NR-U, Long Term Evolution (LTE), LTE-Evolution, LTE-Advanced (LTE-A), Wideband Code Division Multiple Access (WCDMA). Code Division Multiple Access (CDMA), cdma2000, and Global System for Mobile Communications (GSM) and the like. Furthermore, such communication may be performed according to any communication protocol either currently known or to be developed in the future. Examples of the communication protocols include, but are not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first.” “second.” and the like may refer to different or same objects. Other definitions, explicit and implicit, may be included below.

In some examples, values, procedures, or apparatus are referred to as “best,” “lowest,” “highest.” “minimum.” “maximum,” or the like. It will be appreciated that such descriptions are intended to indicate that a selection among many used functional alternatives can be made, and such selections need not be better, smaller, higher, or otherwise preferable to other selections.

Reference to an element in the singular is not intended to mean “one and only one” unless explicitly so stated, but rather is intended to mean “one or more.” Where a phrase similar to “any combination of A, B, C” is used herein, it is intended that the phrase be interpreted to mean that A alone can be present in an embodiment. B alone can be present in an embodiment. C alone can be present in an embodiment, and that any combination of the elements A, B, and C can be present in a single embodiment. For example, any combination of the elements A. B. and C includes the combinations of: A and B. A and C. B and C, and A and B and C can each be present in an embodiment.

When elements, such as A and B, are described as being “A/B” or a “/” is used, then the description is intended to cover all the following combinations: A alone. B alone, or A and B together.

As mentioned above, it is possible to introduce the LBT mechanism in NR-U to the sidelink transmission, so that the sidelink transmission can co-existed with other wireless systems on the unlicensed band. Before each sidelink transmission, the sidelink UE can perform a LBT procedure to occupy the channel and drop the sidelink transmission if LBT fails.

However, there is no autonomous retransmission scheme on the sidelink. Furthermore, there is no Configure Grant (CG) related timers to trigger autonomous retransmission in available CG occasion either.

In a sidelink transmission, there are two resource allocation modes for the sidelink UE, namely mode 1 and mode 2. In resource allocation mode 1, the resources for a sidelink transmission initiated from a transmitting (TX) sidelink UE can be scheduled by a gNB. In resource allocation mode 2, the TX sidelink UE can select the resources for a sidelink transmission from a resource pool by itself. For each resource allocation mode, how to retransmit the data packet that fails to be transmitted in a sidelink transmission due to a LBT failure needs to be discussed.

Furthermore, for the mode 1 CG transmission, to determine when to flush Hybrid Automatic Repeat request (HARQ) buffer, the Tx UE is configured with the parameter sl-MaxTransNum. The Tx UE will flush HARQ buffer when the transmission number during one sidelink CG period reached sl-MaxTransNum. It is to be discussed whether a sidelink transmission, which is failed due to a LBT failure, should be counted as one transmission to compare with sl-MaxTransNum.

Therefore, embodiments of the present disclosure provide a solution for handling LBT failure for sidelink transmission. In this solution, if a TX sidelink UE detects at least one LBT failure during a sidelink transmission procedure from the TX sidelink UE, the TX sidelink UE can obtain a one or more resources for retransmitting data that has failed to be transmitted in the sidelink transmission procedure due to the at least one LBT failure. After the one or more resources for retransmitting data is obtained, the TX sidelink UE can retransmit the data on the obtained one or more resources in a further sidelink transmission procedure from the TX sidelink UE.

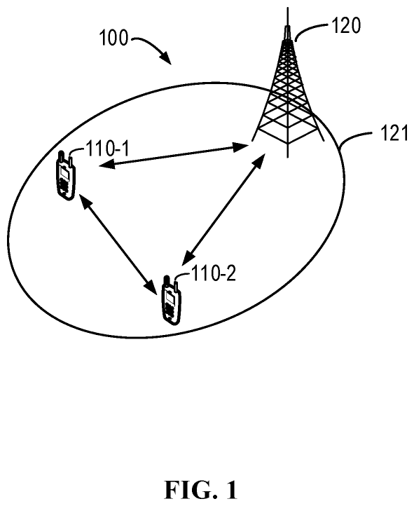

Some example embodiments of the present disclosure will be described in detail below with reference to FIGS. 1-7.

### Example Environment

FIG. 1 illustrates a communication system 100 in which example embodiments of the present disclosure can be implemented. The communication system 100 comprises a network device 120 (hereinafter may also be referred to as a gNB 120). The network device 120 is associated with one or more serving areas, i.e. a land area called “cells”. As shown in FIG. 1, the network device 120 may serve a cell 121.

The communication system 100 can also comprise a terminal device 110-1 and a terminal device 110-2. The network device 120 and the terminal devices 110-1 and 110-2 can communicate data and control information to each other. It is to be understood that the number of network devices, terminal devices and/or cells is provided for illustration purpose only without suggesting any limitation to the scope of the present disclosure. The communication system 100 may include any suitable number of network devices, terminal devices and/or cells adapted for implementing the present disclosure.

The communication between the terminal device 110-1 and the terminal device 110-2 can be referred to as the sidelink communication. For example, if a sidelink transmission between the terminal device 110-1 and the terminal device 110-2 is initiated from the terminal device 110-1, the terminal device 110-1 may be considered as a TX sidelink UE and the terminal device 110-2 may be considered as a RX sidelink UE. The sidelink transmission between the terminal device 110-1 and the terminal device 110-2 can be performed via a Physical Sidelink Control Channel (PSCCH) and a Physical Sidelink Shared Channel (PSSCH).

As described above, in resource allocation mode 1, the resources for a sidelink transmission initiated from a TX sidelink UE can be scheduled by a gNB. For example, the gNB 120 can allocate resources for the sidelink transmission initiated from the TX sidelink UE 110-1 via a Physical Downlink Control Channel (PDCCH). In resource allocation mode 2, the TX sidelink UE 110-1 can select the resources for a sidelink transmission initiated from the TX sidelink UE 110-1 from a resource pool by itself.

Transmission of information in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, such communication protocol(s) may further utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Exemplary Processes

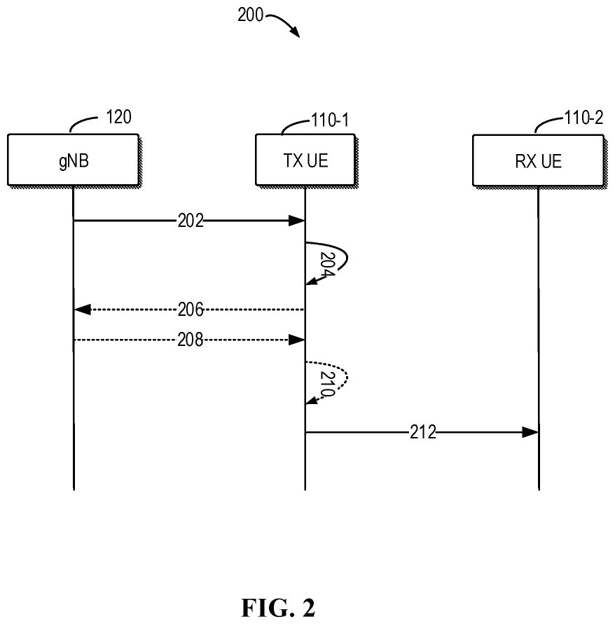

Some exemplary processes for handling LBT failure for sidelink transmission will be described in detail below. Reference is now made to FIG. 2. FIG. 2 illustrates a signaling chart demonstrating an example process 200 for handling LBT failure for sidelink transmission according to some embodiments of the present disclosure. For the purpose of this discussion, the process 200 will be described with reference to FIG. 1. The process 200 may involve the TX sidelink UE 110-1, the RX sidelink UE 110-2 and the gNB 120 as illustrated in FIG. 1.

As shown in FIG. 2, in a case where the resource allocation mode 1 is adopted, the gNB 120 can allocate a one or more resources for a sidelink transmission procedure to be initiated by the TX sidelink UE 110-1 and transmit 202 the information about the allocated one or more resources to the TX sidelink UE 110-1 via a PDCCH between the gNB 120 and the TX sidelink UE 110-1.

After receiving information from the gNB 120, the TX sidelink UE 110-1 can determine the one or more resources and initiate a sidelink transmission procedure from the TX sidelink UE 110-1 to the RX sidelink UE 110-2. The sidelink transmission procedure can comprise one or more sidelink transmission(s).

Before each sidelink transmission in the sidelink transmission procedure, a LBT procedure can be performed for occupying the channel. If the TX sidelink UE 110-1 determines that the sidelink transmission procedure is not successfully performed due to at least one LBT failure during the sidelink transmission procedure, the TX sidelink UE 110-1 needs to request new resources to retransmit the data that has failed to be transmitted in the sidelink transmission procedure.

In an exemplary embodiment, the TX sidelink UE 110-1 can be configured with a Physical Uplink Control Channel (PUCCH) between the TX sidelink UE 110-1 and the gNB 120. In this case, the TX sidelink UE 110-1 can transmit 206 an indication of an unsuccessful data transmission via the PUCCH to the gNB 120. For example, the indication can be represented as “NACK”.

The TX sidelink UE 110-1 can request the new resources for retransmitting the data that has failed to be transmitted in the sidelink transmission procedure in different scenarios.

In an exemplary embodiment, if the TX sidelink UE 110-1 determines that a single LBT failure on a specific data transmission in a plurality of data transmissions during the sidelink transmission procedure is detected, the TX sidelink UE 110-1 can determine that the sidelink transmission procedure is dropped and request the retransmission scheduling from the gNB 120.

In an exemplary embodiment, the specific data transmission can be considered as the most recent sidelink data transmission of the plurality of data transmissions during the sidelink transmission procedure.

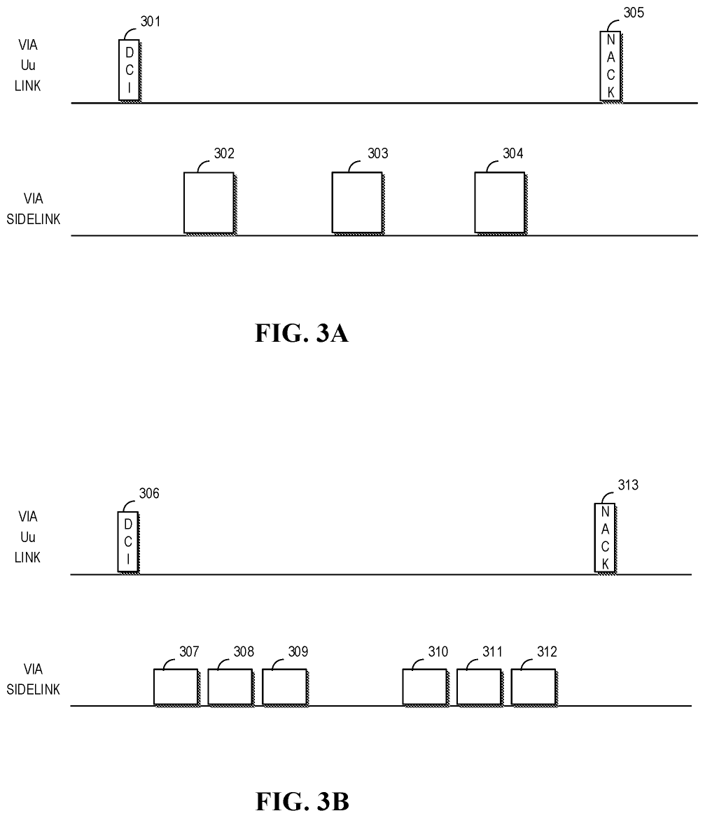

FIG. 3A illustrates an example scenario of LBT failure in a sidelink transmission procedure according to some embodiments of the present disclosure. As shown in FIG. 3A, the TX sidelink UE 110-1 can receive Downlink Control Information (DCI) 301 from the gNB 120 by a PDCCH between the gNB 120 and the TX sidelink UE 110-1 via a Uu link. Multiple resources 302, 303 and 304 can be reserved by the DCI from gNB 120 for the same Transport Block (TB) to be transmitted in a sidelink transmission procedure. It is to be understood that the multiple reserved resources 302-304 can also be configured by a Radio Resource Control (RRC) configuration from gNB 120.

In the sidelink, the TX sidelink UE 110-1 can perform a data transmission on the first resource, i.e. the resource 302 after a successful LBT. If the data transmission is acknowledged with NACK from the RX sidelink UE 110-2 via a Physical Sidelink Feedback Channel (PSFCH), the TX sidelink UE 110-1 can perform the data transmission on the second resource, i.e. the resource 303 after LBT success. If the data transmission is still acknowledged with NACK from the RX sidelink UE 110-2 via a PSFCH, the TX sidelink UE 110-1 can initiate the data transmission on the third resource, i.e. the resource 304. If the TX sidelink UE 110-1 determines that a LBT failure on the resource 304 is detected, the TX sidelink UE 110-1 can determine that the sidelink transmission procedure has failed. Then the TX sidelink UE 110-1 can be triggered to signal the indication “NACK” 305 on PUCCH to gNB 120, to indicate an unsuccessful data transmission.

It is to be understood that the specific sidelink data transmission can also be any other sidelink transmission of the plurality of data transmissions.

In an exemplary embodiment, if the TX sidelink UE 110—detects a plurality of LBT failures during the sidelink transmission procedure, the TX sidelink UE 110-1 can drop the sidelink transmission procedure and request the retransmission scheduling from the gNB 120.

In an exemplary embodiment, the set of data transmission can be considered as the most recent sidelink data transmissions of the plurality of data transmissions during the sidelink transmission procedure.

FIG. 3B illustrates a further example scenario of LBT failure in a sidelink transmission procedure according to some embodiments of the present disclosure. As shown in FIG. 3B, the TX sidelink UE 110-1 can receive DCI 306 from the gNB 120 by a PDCCH between the gNB 120 and the TX sidelink UE 110-1 via the Uu link. Six resources 307-312 can be reserved by the DCI from gNB 120 for the same TB to be transmitted in a sidelink transmission procedure. It is to be understood that the multiple reserved resources 307-312 can also be configured by a RRC configuration from gNB 120.

In contrast with the scenario of the FIG. 3A, in FIG. 3B, the first three resources 307-309 are continuously utilized for sidelink data transmission and next three resources 310-312 are continuously utilized for sidelink data transmission. The HARQ feedback on the sidelink transmission applies for each three transmissions bundle. In a sidelink transmission procedure, for the first three transmissions on the resources 307-309, if the TX sidelink UE 110-1 is acknowledged with NACK from the RX sidelink UE 110-2 on the PSFCH, the TX sidelink UE 110-1 can retransmit the data on the next three resources 310-312. For the next three transmissions, if the TX sidelink UE 110-1 detects the LBT failure for each transmission and the sidelink transmission procedure is dropped, the TX sidelink UE 110-1 can be triggered to signal the indication “NACK” 313 on PUCCH to the gNB 120.

Referring back to FIG. 2, after receiving the indication “NACK” from the TX sidelink UE 110-1, the gNB 120 can transmit 208 the retransmission scheduling to the TX sidelink UE 110-1.

In an exemplary embodiment, the PUCCH between the TX sidelink UE 110-1 and the gNB 120 may not be configured for the TX sidelink UE 110-1. In this case, the TX sidelink UE 110-1 can be triggered to initiate an autonomous retransmission procedure. In an exemplary embodiment, the TX sidelink UE 110-1 can be configured to enable autonomous retransmission by the network or the pre-configuration.

In a case where the PUCCH is not configured, different conditions can trigger the TX sidelink UE 110-1 to initiate an autonomous retransmission procedure. As an option, if a data transmission on the last PSSCH transmission opportunity that is reserved by the network within the sl-periodCG of the CG for a sidelink transmission procedure is performed and the LBT failure is detected, the TX sidelink UE 110-1 can be triggered to perform the autonomous retransmission. As another option, if a data transmission on the any PSSCH transmission opportunity that reserved by the network within the sl-periodCG of the CG a sidelink transmission procedure is performed and the LBT failure is detected, the TX sidelink UE 110-1 can be triggered to perform the autonomous retransmission.

It is also possible that if data transmissions on the more than one PSSCH transmission opportunities that reserved by the network within the sl-periodCG of the CG for a sidelink transmission procedure are performed and the LBT failures are detected, the TX sidelink UE 110-1 can be triggered to perform the autonomous retransmission. Alternatively, if data transmissions on all PSSCH transmission opportunities that reserved by the network within the sl-periodCG of the CG for a sidelink transmission procedure are performed and the LBT failures are detected, the TX sidelink UE 110-1 can be triggered to perform the autonomous retransmission.

In another exemplary embodiment, if the number of the LBT failures occurred on multiple data transmissions during a sidelink transmission procedure exceeds a threshold number, the TX sidelink UE 110-1 can be triggered to perform the autonomous retransmission.

After the TX sidelink UE 110-1 is triggered to perform the autonomous retransmission, the TX sidelink UE 110-1 can determine 210 a further one or more resources for the autonomous retransmission procedure, to retransmit the data that has failed to be transmitted.

If the TX sidelink UE 110-1 is in the resource allocation mode 1, there are two resource selection mechanisms for the TX sidelink UE 110-1 to determine a further one or more resources to perform the autonomous retransmission procedure.

In an exemplary embodiment, the TX sidelink UE 110-1 can autonomously retransmit the data in the next CG occasion in the CG configuration scheduled by the gNB 120 for the sidelink transmission procedure during which the data has failed to be transmitted.

FIG. 3C illustrates an exemplary scenario of resource selection for a sidelink retransmission according to some embodiments of the present disclosure. As shown in FIG. 3C, the TX sidelink UE 110-1 can start a sidelink transmission procedure in the first CG occasion, i.e. resource 314. Assuming that the sidelink data transmission on the resource 314 is acknowledged with NACK from the RX sidelink UE 110-2 via a PSFCH and the sidelink data transmission on the resource 314 is failed due to LBT failure, the TX sidelink UE 110-1 can autonomously retransmit the data in next CG occasion, i.e. resource 316.

In another exemplary embodiment, the TX sidelink UE 110-1 can switch from the resource allocation mode 1 to the resource allocation mode 2, to autonomously select a resource from a resource pool for the resource allocation mode 2 for the autonomous retransmission.

FIG. 3D illustrates a further example scenario of resource selection for a sidelink retransmission according to some embodiments of the present disclosure. As shown in FIG. 3D, the TX sidelink UE 110-1 can start a sidelink transmission procedure in the first CG occasion, i.e. resource 317. Assuming that the sidelink data transmission on the resource 317 is acknowledged with NACK from the RX sidelink UE 110-2 via a PSFCH and the sidelink data transmission on the resource 318 is failed due to LBT failure, the TX sidelink UE 110-1 can switch from the resource allocation mode 1 to the resource allocation mode 2.

Then the TX sidelink UE 110-1 can obtain a resource pool configured for the resource allocation mode 2 and autonomously select a resource from the resource pool for the autonomous retransmission. For example, the TX sidelink UE 110-1 can select resource 319 for the autonomous retransmission.

It is possible that the TX sidelink UE 110-1 can also be scheduled by gNB to perform other transmissions, for example, in the mode 1 resource pool and overlap with resource 319 in time domain. If the resource selected for the autonomous retransmission overlaps with a further resource scheduled for other transmission by the gNB 120, the TX sidelink UE 110-1 can compare a first priority of the data to be transmitted in autonomous retransmission and a second priority of a further data to be to be transmitted in the other transmission scheduled by the gNB 120. The TX sidelink UE 110-1 can transmit the data which has higher priority. In an exemplary embodiment, the priority of the date can be determined by the highest priority of logical channel that multiplexed in this data.

Now referring back to FIG. 2, after the resources for retransmitting the data is determined, the TX sidelink UE 110-1 can retransmit 212 the data on the determined resources to the RX sidelink UE 110-2.

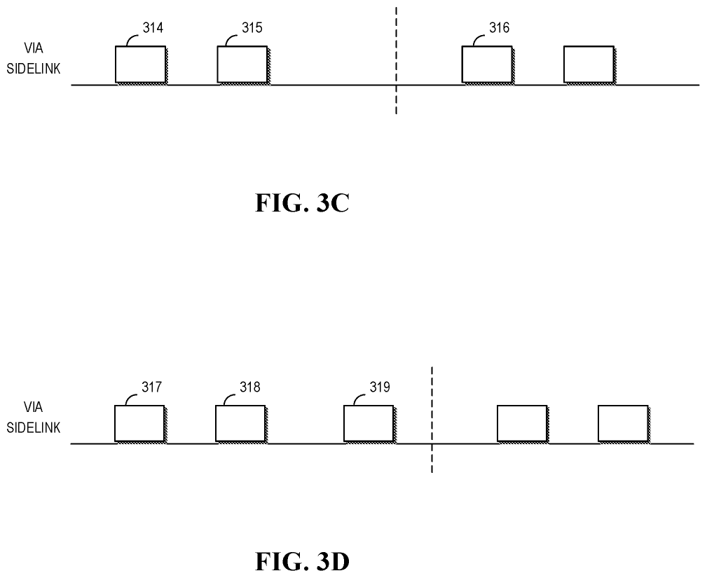

Reference is now made to FIG. 4. FIG. 4 illustrates a signaling chart demonstrating an example process 400 for handling LBT failure for sidelink transmission according to some embodiments of the present disclosure. For the purpose of this discussion, the process 400 will be described with reference to FIG. 1. The process 200 may involve the TX sidelink UE 110-1, the RX sidelink UE 110-2 and the gNB 120 as illustrated in FIG. 1.

As shown in FIG. 4, in a case where the resource allocation mode 2 is adopted, the TX sidelink UE 110-1 can select a one or more resources for a sidelink transmission procedure from a resource pool configured for the resource allocation mode 2 and initiate 402 the sidelink transmission procedure on the one or more resources.

If the sidelink transmission procedure is dropped, the TX sidelink UE 110-1 can be triggered to reselect 404 a resource from the resource pool for performing the autonomous retransmission. Different conditions can trigger the TX sidelink UE 110-1 to initiate an autonomous retransmission procedure in the resource allocation mode 2. As an option, if one of data transmissions or data retransmissions in the sidelink transmission procedure is performed and the LBT failure is detect on the data transmission, the TX sidelink UE 110-1 can be triggered to remove the dropped sidelink grant and reselect a resource from the resource pool for the autonomous retransmission.

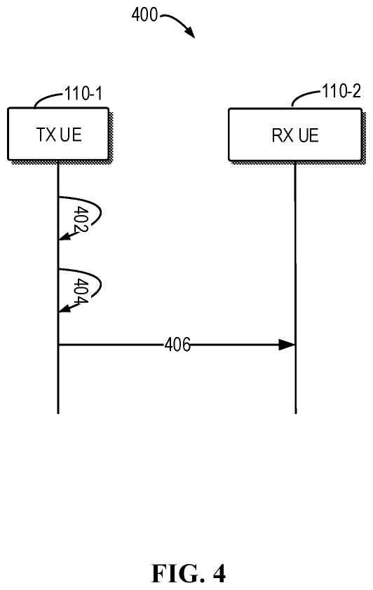

FIG. 5A illustrates an exemplary scenario for triggering a resource reselection for a sidelink retransmission caused by LBT failure according to some embodiments of the present disclosure. As shown in FIG. 5A, multiple resources 501-503 can be reserved by the TX sidelink UE 110-1 for a sidelink transmission procedure. If a LBT failure on the resource 502 is detected, the TX sidelink UE 110-1 can be triggered to remove the dropped sidelink grant and reselect a resource from the resource pool for the autonomous retransmission.

In another exemplary embodiment, it is also possible that only if the number of the LBT failures occurred during a sidelink transmission procedure exceeds a threshold number, that the TX sidelink UE 110-1 be triggered to remove the dropped sidelink grant and reselect a resource from the resource pool for the autonomous retransmission.

As another option, if more than one LBT failures are detected on multiple data transmissions or data retransmissions in the sidelink transmission procedure, the TX sidelink UE 110-1 can be triggered to remove the dropped sidelink grant and reselect a resource from the resource pool for the autonomous retransmission.

FIG. 5B illustrates an example scenario for triggering a resource reselection for a sidelink retransmission caused by LBT failure according to some embodiments of the present disclosure. As shown in FIG. 5A, Six resources 504-509 can be reserved by the DCI from gNB 120 for the same TB to be transmitted in a sidelink transmission procedure. The first three resources 504-506 are continuously and next three resources 507-509 are continuously.

The HARQ feedback on the sidelink is for each three transmissions bundle. In a sidelink transmission procedure, for the first three transmissions on the resources 504-506, if the TX sidelink UE 110-1 is acknowledged with NACK from the RX sidelink UE 110-2 on the PSFCH, the TX sidelink UE 110-1 can retransmit the data on the next three resources 507-509. For the next three transmissions, if the TX sidelink UE 110-1 detects the LBT failure for each transmission and the sidelink transmission procedure is dropped, the TX sidelink UE 110-1 can be triggered to remove the dropped sidelink grant and reselect a resource from the resource pool for the autonomous retransmission.

Alternatively, when all data transmissions in a sidelink transmission procedure are blocked by the LBT failures, the TX sidelink UE 110-1 can be triggered to remove the dropped sidelink grant and reselect a resource from the resource pool for the autonomous retransmission.

It is also possible that only when a priority of a data that has failed to be transmitted in a sidelink transmission procedure due to a LBT failure, the TX sidelink UE 110-1 can be triggered to remove the dropped sidelink grant and reselect a resource from the resource pool for the autonomous retransmission.

Now referring back to FIG. 4, after reselecting the resource from the resource pool for the autonomous retransmission, the TX sidelink UE 110-1 can perform 406 the autonomous retransmission on the reselected resource.

As mentioned above, an issue to be discussed in the present disclosure is whether a sidelink transmission, which is failed due to a LBT failure, should be counted as one transmission to compare with sl-MaxTransNum. If a sidelink data transmission for a CG period is blocked by the LBT failure, i.e. MAC received LBT failure indication from lower layer for the transmission, TX sidelink UE 110-1 cannot count this sidelink data transmission as the actual performed transmission and this sidelink data transmission is not count to compare with sl-MaxTransNum.

In the present disclosure, a mechanism for data retransmission cause by the LBT failure in the sidelink commutation is specified, which is benefit for the sidelink to co-exist with other wireless technologies in NR.

Exemplary Method

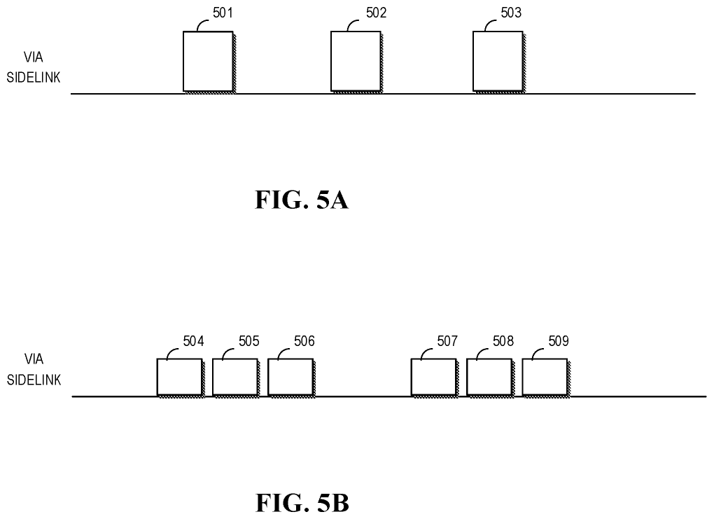

FIG. 6 illustrates a flowchart of an example method 600 according to some embodiments of the present disclosure. The method 600 can be performed by the terminal device 110-1 as shown in FIG. 1. It is to be understood that the method 600 may include additional blocks not shown and/or may omit some blocks as shown, and the scope of the present disclosure is not limited in this regard. For the purpose of discussion, the method 400 will be described from the perspective of the terminal device 110-1 with reference to FIG. 1.

At 610, in response to at least one LBT failure during a sidelink transmission procedure, the terminal device 110 determines a one or more resources for transmitting data from the terminal device 110, the data has failed to be transmitted due to the at least one LBT failure.

In an exemplary embodiment, in response to a single LBT failure during the sidelink transmission procedure, the terminal device 110 can transmit, to a network device, an indication of an unsuccessful data transmission via a control channel between the terminal device and the network device and receiving, from the network device via the control channel, information about the one or more resources for retransmitting the data from the terminal device.

In an exemplary embodiment, in response to a plurality of LBT failures during the sidelink transmission procedure, the terminal device 110 can transmit, to a network device, an indication of an unsuccessful data transmission via a control channel between the terminal device and the network device and receiving, from the network device via the control channel, information about the one or more resources for retransmitting the data from the terminal device.

In an exemplary embodiment, the control channel is a physical uplink control channel.

In an exemplary embodiment, the terminal device 110-1 can initiate an autonomous retransmission procedure of the terminal device and obtain the one or more resources for the autonomous retransmission procedure.

In an exemplary embodiment, in response to a single LBT failure during the sidelink transmission procedure, the terminal device 110-1 can initiate an autonomous retransmission procedure.

In an exemplary embodiment, in response to a plurality of LBT failures during the sidelink transmission procedure, the terminal device 110-1 can initiate an autonomous retransmission procedure.

In an exemplary embodiment, in response to the number of the at least one LBT failure exceeding a threshold number, the terminal device 110-1 can initiate an autonomous retransmission procedure.

In an exemplary embodiment, the terminal device 110-1 can determine the one or more resources for the autonomous retransmission procedure from a CG for data retransmission from the terminal device.

In an exemplary embodiment, the CG is configured by a network device.

In an exemplary embodiment, the terminal device 110-1 can determine the one or more resources for the autonomous retransmission procedure by switching from a first resource allocation mode of the terminal device to a second resource allocation mode of the terminal device and selecting the one or more resources from a resource pool configured for data retransmission from the terminal device.

In an exemplary embodiment, the terminal device 110-1 can determine the one or more resources for the autonomous retransmission procedure by reselecting the one or more resources from a resource pool configured for data retransmission from the terminal device.

At 620, the terminal device 110-1 transmits the data via the one or more resources as determined.

In an exemplary embodiment, in response to the sidelink transmission procedure overlapping with another sidelink transmission procedure, the terminal device 110-1 can determine respective priorities of the data to be transmitted; and transmit the data that is of a higher priority from the terminal device.

In an exemplary embodiment, in response to a reference data transmission during the sidelink transmission procedure failing due to the at least one LBT failure, the terminal device 110-1 can exclude the reference data transmission when counting the number of data transmissions allowed for the sidelink transmission procedure.

Exemplary Apparatus

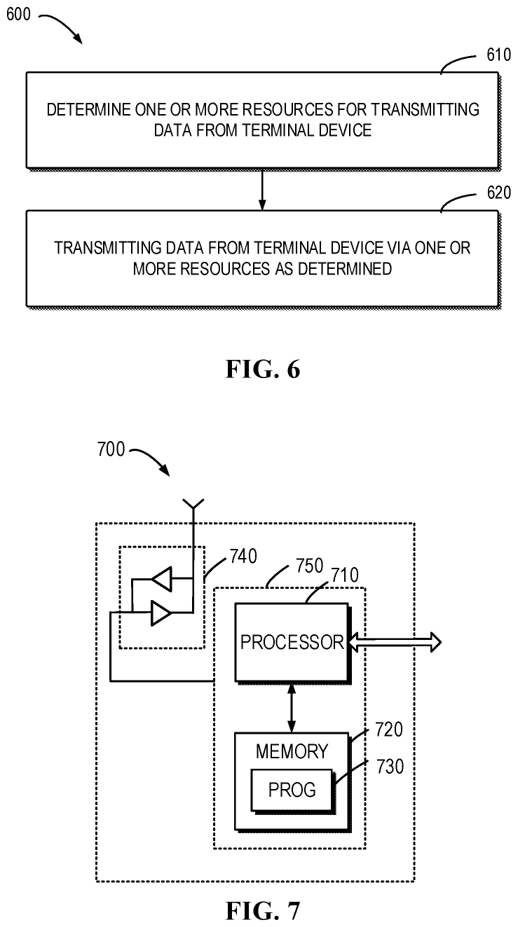

FIG. 7 is a simplified block diagram of an apparatus 700 that is suitable for implementing embodiments of the present disclosure. The apparatus 700 can be considered as a further example implementation of the terminal device 110-1 as shown in FIG. 1. Accordingly, the apparatus 700 can be implemented at or as at least a part of the terminal device 110-1.

As shown, the apparatus 700 includes a processor 710, a memory 720 coupled to the processor 710, and a suitable transmitter (TX) and receiver (RX) 740 coupled to the processor 710. The memory 710 stores at least a part of a program 730. The TX/RX 740 is for bidirectional communications. The TX/RX 740 is coupled to at least one antenna to facilitate communication, though, in practice, an Access Node mentioned in this application may have several antennas. The processor 710 can be coupled to a communication interface (not shown). The communication interface may represent any interface that is necessary for communication with other network elements, such as X2 interface for bidirectional communications between eNBs. S1 interface for communication between a Mobility Management Entity (MME)/Serving Gateway (S-GW) and the eNB, Un interface for communication between the eNB and a relay node (RN), or Uu interface for communication between the eNB and a terminal device.

A program 730 is assumed to include program instructions that, when executed by the associated processor 710, enable the apparatus 700 to operate in accordance with the embodiments of the present disclosure, as discussed herein with reference to FIGS. 2-6. The embodiments herein may be implemented by computer software executed by the processor 710 of the apparatus 700, or by other hardware, or by a combination of software and hardware. The processor 710 may be configured to implement various embodiments of the present disclosure. Furthermore, a combination of the processor 710 and memory 710 may form processing means 750 adapted to implement various embodiments of the present disclosure.

The memory 710 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 710 is shown in the apparatus 700, there may be several physically distinct memory modules in the apparatus 700. The processor 710 may be of any type suitable to the local technical network, and may include one or more of general purpose computers, special purpose computers, microprocessors, digital signal processors (DSPs) and processors based on multicore processor architecture, as non-limiting examples. The apparatus 700 may have multiple processors, such as an application specific integrated circuit chip that is slaved in time to a clock which synchronizes the main processor.

In an exemplary embodiment, an apparatus for performing the method 600 (for example, the terminal device 110-1) may comprise respective means for performing the corresponding steps in the method 600. These means may be implemented in any suitable manners. For example, it can be implemented by circuitry or software modules.

In an exemplary embodiment, the apparatus comprises means for in response to at least one LBT failure during a sidelink transmission procedure, determining one or more resources for transmitting data from the terminal device, the data has failed to be transmitted due to the at least one LBT failure and means for transmitting the data from the terminal device via the one or more resources as determined.

In an exemplary embodiment, the means for determining the one or more resources for transmitting the data from the terminal device can comprise means for in response to a single LBT failure during the sidelink transmission procedure, transmitting, to a network device, an indication of an unsuccessful data transmission via a control channel between the terminal device and the network device and means for receiving, from the network device via the control channel, information about the one or more resources for retransmitting the data from the terminal device.

In an exemplary embodiment, the means for determining the one or more resources for transmitting the data from the terminal device can comprise means for in response to a plurality of LBT failures during the sidelink transmission procedure, transmitting, to a network device, at least an indication of unsuccessful data transmissions via a control channel between the terminal device and the network device and means for receiving, from the network device via the control channel, information about the one or more resources for retransmitting the data from the terminal device.

In an exemplary embodiment, the control channel is a physical uplink control channel.

In an exemplary embodiment, the means for determining the one or more resources for transmitting the data from the terminal device can comprise means for initiating an autonomous retransmission procedure to retransmit the data from the terminal device and means for obtaining the one or more resources for the autonomous retransmission procedure.

In an exemplary embodiment, the means for initiating the autonomous retransmission procedure can comprise means for in response to a single LBT failure during the sidelink transmission procedure, initiating the autonomous retransmission procedure.

In an exemplary embodiment, the means for initiating the autonomous retransmission procedure can comprise means for in response to a plurality of LBT failures during the sidelink transmission procedure, initiating the autonomous retransmission procedure.

In an exemplary embodiment, the means for initiating the autonomous retransmission procedure can comprise means for in response to the number of the at least one LBT failure exceeding a threshold number, initiating the autonomous retransmission procedure.

In an exemplary embodiment, the means for determining the one or more resources for the autonomous retransmission procedure can comprise means for determining the one or more resources for retransmitting the data from a CG for data retransmission from the terminal device.

In an exemplary embodiment, the CG is configured by a network device.

In an exemplary embodiment, the means for determining the one or more resources for the autonomous retransmission procedure can comprise means for switching from a first resource allocation mode of the terminal device to a second resource allocation mode of the terminal device and means for selecting the one or more resources from a resource pool configured for data retransmission from the terminal device.

In an exemplary embodiment, the means for determining the one or more resources for the autonomous retransmission procedure can comprise means for reselecting the one or more resources from a resource pool configured for data retransmission from the terminal device.

In an exemplary embodiment, the means for retransmitting the data can comprise means for in response to the sidelink transmission procedure overlapping with another sidelink transmission procedure, determining respective priorities of the data to be transmitted and means for transmitting the data that is of a higher priority from the terminal device.

In an exemplary embodiment, the apparatus can further comprise means for in response to a reference data transmission during the sidelink transmission procedure failing due to the at least one LBT failure, excluding the reference data transmission when counting the number of data transmissions allowed to be performed in the sidelink transmission procedure.

Example embodiments of the present disclosure provide a solution for handling LBT failure for sidelink transmission.

In an exemplary embodiment, there is provided a method performed by a terminal device. The method comprises in response to at least one LBT failure during a sidelink transmission procedure, determining one or more resources for transmitting data from the terminal device, the data has failed to be transmitted due to the at least one LBT failure; and transmitting the data from the terminal device via the one or more resources as determined.

In an exemplary embodiment, obtaining the one or more resources comprises in response to a single LBT failure during the sidelink transmission procedure, transmitting, to the network device, an indication of an unsuccessful data transmission via a control channel between the terminal device and the network device; and receiving, from the network device, via the control channel information about the one or more resources for retransmitting the data from the terminal device.

In an exemplary embodiment, obtaining the one or more resources comprises in response to a plurality of LBT failures during the sidelink transmission procedure are detected, transmitting, to the network device, an indication of an unsuccessful data transmission via a control channel between the terminal device and the network device; and receiving, from the network device, via a control channel information about the one or more resources for retransmitting the data from the terminal device.

In an exemplary embodiment, the control channel is a physical uplink control channel.

In an exemplary embodiment, determining the one or more resources comprises initiating an autonomous retransmission procedure of the terminal device; and obtaining the one or more resources for the autonomous retransmission procedure.

In an exemplary embodiment, initiating the autonomous retransmission procedure comprises in response to a single LBT failure during the sidelink transmission procedure, initiating the autonomous retransmission procedure.

In an exemplary embodiment, initiating the autonomous retransmission procedure comprises in response to a plurality of LBT failures during the sidelink transmission procedure, initiating the autonomous retransmission procedure.

In an exemplary embodiment, initiating the autonomous retransmission procedure comprises in response to the number of the at least one LBT failure exceeding a threshold number, initiating the autonomous retransmission procedure.

In an exemplary embodiment, determining the one or more resources for the autonomous retransmission procedure comprises obtaining the one or more resources for retransmitting the data from a CG for data retransmission from the terminal device.

In an exemplary embodiment, the CG is configured by a network device.

In an exemplary embodiment, determining the one or more resources for the autonomous retransmission procedure comprises switching from a first resource allocation mode of the terminal device to a second resource allocation mode of the terminal device; and selecting the one or more resources from a resource pool configured for data retransmission from the terminal device.

In an exemplary embodiment, determining the one or more resources for the autonomous retransmission procedure comprises reselecting the one or more resources from a resource pool configured for data retransmission from the terminal device.

In an exemplary embodiment, retransmitting the data comprises in response to the sidelink transmission procedure overlapping with another sidelink transmission procedure, determining respective priorities of the data to be transmitted; and transmitting the data that is of a higher priority from the terminal device.

In an exemplary embodiment, the method can further comprise in response to a reference data transmission during the sidelink transmission procedure failing due to the at least one LBT failure, excluding the reference data transmission when counting the number of data transmissions allowed for the sidelink transmission procedure.

In an exemplary embodiment, there is provided an apparatus. The apparatus comprises a processor and a memory coupled to the processor and storing instructions thereon, the instructions, when executed by the processor, causing the apparatus to perform the method as described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
a processor; and
a transceiver coupled to the processor, wherein the processor is configured to:
in response to at least one Listen Before Talk (LBT) failure during a sidelink transmission procedure, determine one or more resources for transmitting data that has failed to be transmitted from the terminal device due to the at least one LBT failure; and
transmit the data from the terminal device via the one or more resources as determined.

2. The terminal device of claim 1, wherein the processor is further configured to:
transmit, in response to a single LBT failure during the sidelink transmission procedure, and to a network device, an indication of an unsuccessful data transmission via a control channel between the terminal device and the network device; and
receive, from the network device via the control channel, information about the one or more resources for retransmitting the data from the terminal device.

3. The terminal device of claim 1, wherein the processor is further configured to:
transmit, in response to a plurality of LBT failures during the sidelink transmission procedure, and to a network device, at least an indication of unsuccessful data transmissions via a control channel between the terminal device and the network device; and
receive, from the network device via the control channel, information about the one or more resources for retransmitting the data from the terminal device.

4. The terminal device of claim 2, wherein the control channel is a physical uplink control channel.

5. The terminal device of claim 1, wherein the processor is further configured to:
initiate an autonomous retransmission procedure to retransmit the data from the terminal device; and
determine the one or more resources for the autonomous retransmission procedure.

6. The terminal device of claim 5, wherein the processor initiates the autonomous retransmission procedure by:
initiating the autonomous retransmission procedure in response to a single LBT failure during the sidelink transmission procedure.

7. The terminal device of claim 5, wherein the processor initiates the autonomous retransmission procedure by:
initiating the autonomous retransmission procedure in response to a plurality of LBT failures during the sidelink transmission procedure.

8. The terminal device of claim 5, wherein the processor initiates the autonomous retransmission procedure by:
initiating the autonomous retransmission procedure in response to a number of the at least one LBT failure exceeding a threshold number.

9. The terminal device of claim 5, wherein the processor is further configured to:
determine the one or more resources for retransmitting the data from a Configure Grant (CG) for data retransmission from the terminal device.

10. The terminal device of claim 9, wherein the CG is configured by a network device.

11. The terminal device of claim 5, wherein the processor is further configured to:
switch from a first resource allocation mode of the terminal device to a second resource allocation mode of the terminal device; and
select the one or more resources from a resource pool for data retransmission from the terminal device.

12. The terminal device of claim 5, wherein the processor is further configured to:
reselect the one or more resources from a resource pool for data retransmission from the terminal device.

13. The terminal device of claim 1, wherein the processor transmits the data from the terminal device by:
determining respective priorities of the data to be transmitted in response to the sidelink transmission procedure overlapping with another sidelink transmission procedure; and
transmitting the data that is of a higher priority from the terminal device.

14. The terminal device of claim 1, wherein the processor is further configured to:
in response to a reference data transmission during the sidelink transmission procedure failing due to the at least one LBT failure, exclude the reference data transmission when counting the number of data transmissions allowed for the sidelink transmission procedure.

15. (canceled)

16. A processor for wireless communication, comprising:
at least one memory; and
a controller coupled with the at least one memory and configured to cause the processor to:
in response to at least one Listen Before Talk (LBT) failure during a sidelink transmission procedure, determine one or more resources for transmitting data that has failed to be transmitted from the terminal device due to the at least one LBT failure; and
transmit the data from the terminal device via the one or more resources as determined.

17. The processor of claim 16, wherein the processor is further configured to:
in response to a reference data transmission during the sidelink transmission procedure failing due to the at least one LBT failure, exclude the reference data transmission when counting the number of data transmissions allowed for the sidelink transmission procedure.

18. A method performed by a terminal device, the method comprising:
in response to at least one Listen Before Talk (LBT) failure during a sidelink transmission procedure, determining one or more resources for transmitting data that has failed to be transmitted from the terminal device due to the at least one LBT failure; and
transmitting the data from the terminal device via the one or more resources as determined.

19. The method of claim 18, further comprising:
in response to a reference data transmission during the sidelink transmission procedure failing due to the at least one LBT failure, excluding the reference data transmission when counting the number of data transmissions allowed for the sidelink transmission procedure.

20. A network device, comprising:
a processor; and
a transceiver coupled to the processor, wherein the processor is configured to:
receive, from a terminal device and in response to a single LBT failure during a sidelink transmission procedure, an indication of an unsuccessful data transmission via a control channel between the terminal device and the network device; and
transmit, via the control channel, information about one or more resources for retransmitting the data during the sidelink transmission procedure.
